(19) United States
(12) Patent Application Publication
(10) Pub. No.: US 2015/0091882 A1
(43) Pub. Date: Apr. 2, 2015

(54) PORTABLE TERMINAL AND METHOD OF CONTROLLING THE SAME

(71) Applicant: Samsung Electronics Co., Ltd., Gyeonggi-do (KR)

(72) Inventors: Prasad Dayama DWARKA, Gyeonggi-do (KR); Agarwal PANKAJ, Gyeonggi-do (KR)

(73) Assignee: Samsung Electronics Co., Ltd.

(21) Appl. No.: 14/505,170

(22) Filed: Oct. 2, 2014

(30) Foreign Application Priority Data
Oct. 2, 2013 (KR) 10-2013-0118133

(51) Int. Cl. G06F 3/02

(52) U.S. Cl. CPC G06F 3/0202
USPC 345/184

(57) ABSTRACT

A portable terminal capable of easily protecting the privacy of a user thereof and a method of controlling the portable terminal are provided. The portable terminal includes a display unit configured to display an image, a cover disposed to be rotated with respect to an edge of the display unit as an axis, and a control unit configured to control brightness of the display unit according to an angle formed by a face of the cover and a surface of the display unit.

### PRIORITY

This application claims priority under 35 U.S.C. §119(a) to Korean Patent Application No. 10-2013-0118133, filed on Oct. 2, 2013, in the Korean Intellectual Property Office, the content of which is incorporated herein by reference.

### BACKGROUND

1. Field of the Invention

The present invention relates generally to a portable terminal and a method of controlling the same, and more particularly, to a portable terminal for protecting the privacy of a user thereof and a method of controlling the portable terminal.

2. Description of the Related Art

With the development of communication technology and decrease in the size of electronic devices, personal terminals, such as smart phones, smart pads, and portable consoles, have become more popular.

Portable terminals may include various display devices.

Commonly, a cover is used to protect the display device of the portable terminal from external shocks. The cover may be attached onto the portable terminal. A user may cover the display device with the cover by closing the cover when the portable terminal is not in use. The user may open the cover to use the portable terminal, thereby exposing the display.

When the brightness of the display device is sufficiently high, contents displayed on the display unit may be seen not only by the user, but also by people who near the user. When the content displayed on the display device is recognized by others, the privacy of the user may be violated.

### SUMMARY

The present invention has been made to address at least one of problems and/or disadvantages described above and to provide at least the advantages described below.

Accordingly, an aspect of the present invention is to provide a portable terminal for protecting the privacy of a user thereof and a method of controlling the portable terminal.

Another aspect of the present invention is to provide a portable terminal capable of decreasing power consumption therein and a method of controlling the portable terminal.

Another aspect of the present invention is to provide a portable terminal capable of increasing the duration of a battery therein and a method of controlling the portable terminal.

According to an aspect of the present invention, a portable terminal is provided, which includes a display unit configured to display an image; a cover disposed to be rotated with respect to an edge of the display unit as an axis; and a control unit configured to control brightness of the display unit according to an angle formed by a face of the cover and a surface of the display unit.

According to another aspect of the present invention, a portable terminal is provided, which includes a display unit configured to display an image; a cover disposed to be rotated with respect to an edge of the display unit as an axis; and a control unit configured to control the display unit such that power consumption changes according to an angle formed by a face of the cover and a surface of the display unit.

According to another aspect of the present invention, a method of controlling a portable terminal is provided, which includes detecting an angle formed by a face of a cover and a surface of a display unit included in the portable terminal; and controlling brightness of the display unit according to the angle.

According to another aspect of the present invention, a method of controlling a portable terminal is provided, which includes measuring an intensity of illumination according to an angle formed by a face of a cover and a surface of a display unit included in the portable terminal; and controlling brightness of the display unit according to the measured intensity of illumination.

### BRIEF DESCRIPTION OF THE DRAWINGS

The above and other aspects, features and advantages of a certain embodiment of present invention will become more apparent from the following description, taken in conjunction with the accompanying drawings, in which:

FIG. 1 is a perspective view of a portable terminal according to an embodiment of the present invention;

FIG. 2 is a block diagram of a configuration of a portable terminal according to an embodiment of the present invention;

FIGS. 3 to 5 are diagrams for explaining an operation of a portable terminal according to an embodiment of the present invention;

FIG. 6 is a block diagram of a configuration of a portable terminal according to another embodiment of the present invention;

FIG. 7 is a flowchart of a method of controlling a portable terminal according to an embodiment of the present invention; and

FIG. 8 is a flowchart of a method of controlling a portable terminal according to another embodiment of the present invention.

### DETAILED DESCRIPTION OF EMBODIMENTS OF THE PRESENT INVENTION

Hereinafter, the present invention will be described more fully with reference to the accompanying drawings, in which embodiments of the invention are shown. This invention may, however, be embodied in many different forms and should not be construed as limited to the embodiments set forth herein. Rather, these embodiments are provided so that the description will be thorough and complete, and will fully convey the scope of the present invention to those skilled in the art. The scope of the present invention is defined only in the claims and their equivalents. Like numbers refer to like elements throughout.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items.

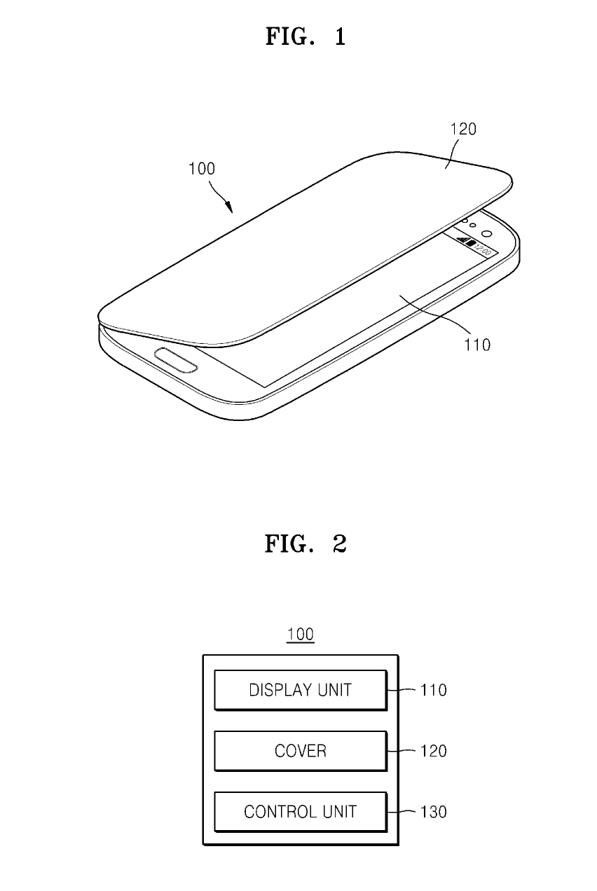

FIG. 1 is a perspective view of a portable terminal 100 according to an embodiment of the present invention. FIG. 2 is a block diagram of a configuration of the portable terminal 100 according to an embodiment of the present invention.

Referring to FIGS. 1 and 2, the portable terminal 100 includes a display unit 110, a cover 120, and a control unit 130.

The display unit 110 displays an image, and updates the image displayed thereon according to a user input or a predetermined condition.

The display unit 110 has a tetragonal shape as illustrated in FIG. 1. According to another embodiment, the display unit 110 may have a triangular, polygonal, circular, or oval shape.

The display unit 110 may be, for example, an Organic Light-Emitting Diode (OLED) display device, a Liquid Crystal Display (LCD) device, an ElectroLuminescent Display (ELD) device, a Plasma Display Panel (PDP), etc. The display unit 110 may include a touch screen.

The cover 120 is disposed to be rotated with respect to an edge of the display unit 110 as an axis. Referring to FIG. 1, the cover 120 is rotated with respect to one of four edges of the display unit 110 having a tetragonal shape as an axis. The cover 120 may be, for example, a flip cover and the like.

A user of the portable terminal 100 may rotate the cover 120 about the axis. The user may rotate the cover 120 such that an angle formed by a face of the cover 120 and a surface of the display unit 110 is 0 degrees. In other words, the user may close the cover 120. Thus, the surface of the display unit 110 is covered with the cover 120.

The user may rotate the cover 120 such that the angle formed by the face of the cover 120 and the surface of the display unit 110 is greater than 0 degrees. In other words, the user may open the cover 120. Thus, the surface of the display unit 110 is exposed by the cover 120. The user may thus view an image displayed on the display unit 110.

The cover 120 may be formed of, for example, a plastic, metal, textile, leather, rubber, or polyurethane material.

The control unit 130 controls the brightness of the display unit 110 according to the angle formed by the face of the cover 120 and the surface of the display unit 110. The control unit 130 may control the brightness of the display unit 110 such that the larger the angle formed by the face of the cover 120 and the surface of the display unit 11, the higher the brightness of the display unit 110. According to another embodiment, the control unit 130 may control the brightness of the display unit 110 such that the smaller the angle formed by the face of the cover 120 and the surface of the display unit 11, the higher the brightness of the display unit 110.

The control unit 130 may control the brightness of the display unit 110 such that the brightness of the display unit 110 continuously changes according to the angle formed by the face of the cover 120 and the surface of the display unit 110. Alternatively, the control unit 130 may control the brightness of the display unit 110 such that the brightness of the display unit 110 discretely changes according to the angle formed by the face of the cover 120 and the surface of the display unit 110.

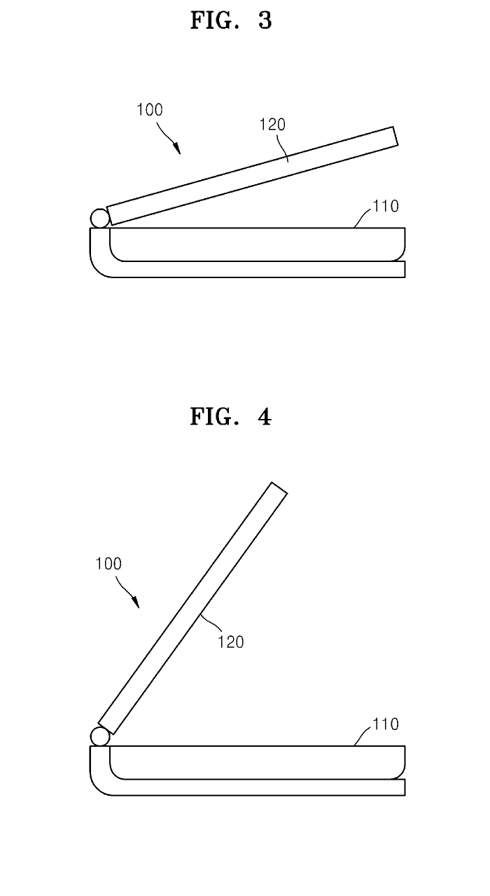

FIGS. 3 to 5 are diagrams for explaining an operation of a portable terminal according to an embodiment of the present invention.

Referring to FIG. 3, an angle formed by a face of the cover 120 and a surface of the display unit 110 is less than 60 degrees.

Referring to FIG. 4, the angle formed by the face of the cover 120 and the surface of the display unit 110 is equal to or greater than 60 degree or is less than 90 degrees.

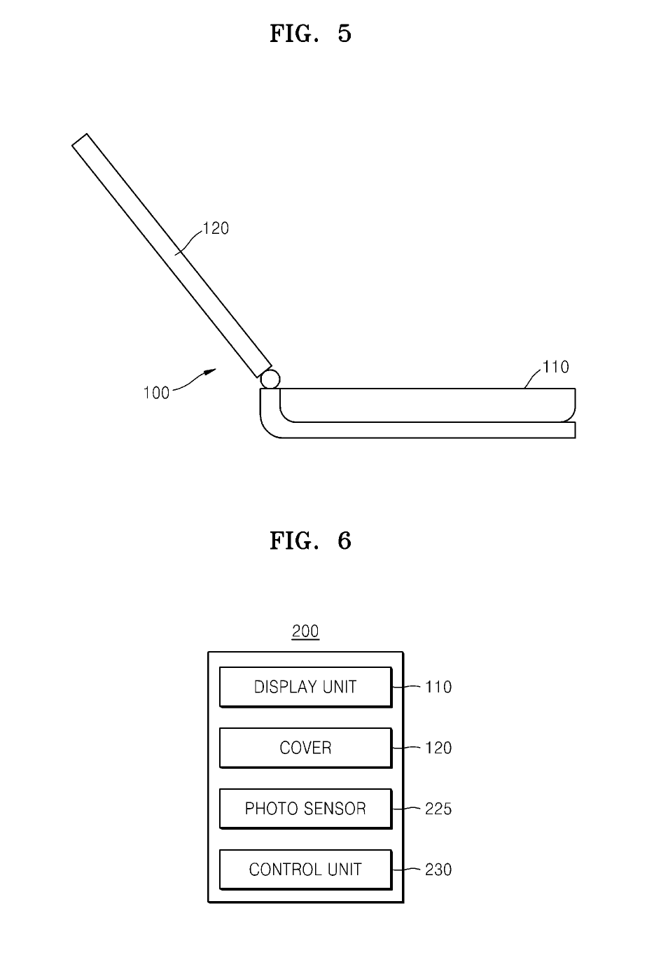

Referring to FIG. 5, the angle formed by the face of the cover 120 and the surface of the display unit 110 is equal to or greater than 90 degrees.

For example, the control unit 130 controls the brightness of the display unit 110 such that the brightness of the display unit 110 when operated as in FIG. 3 is lower than the brightness of the display unit 110 when operated as in FIG. 4. Also, the control unit 130 controls the brightness of the display unit 110 such that the brightness of the display unit 110 when operated as in FIG. 4 is lower than the brightness of the display unit 110 when operated as in FIG. 5.

The control unit 130 may control the bringtness of display unit to protect the user's privacy. For example, when the angle formed by the face of the cover 120 and the surface of the display unit 110 is less than 60 degrees, the control unit 130 controls the brightness of the display unit 110 so that the content displayed on the display unit 110 is recognized only by the user, but not by people who are located adjacent to the user. When the angle formed by the face of the cover 120 and the surface of the display unit 110 is equal to or greater than 60 degrees, the control unit 130 controls the brightness of the display unit 110 so that the content displayed on the display unit 110 is recognized by not only the user but also the people who are located adjacent to the user. Thus, the user may protect his/her privacy by rotating the cover 120.

Power consumption when the brightness of the display unit 110 is high is greater than that when the brightness of the display unit 110 is low. The control unit 130 controls the display unit 110 such that power consumption changes according to the angle formed by the face of the cover 120 and the surface of the display unit 110. For example, the control unit 130 controls the display unit 110 such that power consumption when this angle is less than 60 degrees is less than that when this angle is equal to or greater than 60 degrees. Thus, the user may control the power consumption in the portable terminal 100 by rotating the cover 120. The control unit 130 may control the display unit such that as the angle increases, the power consumption increases. According to another embodiment, the control unit 130 may control the display unit such that as the angle decreases, the power consumption increases.

FIG. 6 is a block diagram of a configuration of a portable terminal 200 according to another embodiment of the present invention. Referring to FIG. 6, the portable terminal 200 includes a display unit 110, a cover 120, a photo sensor 225, and a control unit 230.

The display unit 110 corresponds to the display unit 110 described above with reference to FIG. 2 and thus is not described in detail here.

The cover 120 corresponds to the cover 120 described above with reference to FIG. 2 and thus is not described in detail here.

The photo sensor 225 measures the intensity of illumination, which depends on an angle formed by a face of the cover 120 and a surface of the display unit 110. The larger the angle formed by the face of the cover 120 and the surface of the display unit 110, the higher the intensity of illumination measured by the photo sensor 225. For example, the intensity of illumination measured by the photo sensor 225 may be 189 lux in the example of FIG. 3, may be 220 lux in the example of FIG. 4, and may be 309 lux in the example of FIG. 5.

The control unit 230 controls the brightness of the display unit 110 based on the measured intensity of illumination. The control unit 230 may control the brightness of the display unit 110 such that the higher the measured intensity of illumination, the higher the brightness of the display unit 110.

According to another embodiment, the control unit 230 may control the brightness of the display unit 110 such that the lower the measured intensity of illumination, the higher the brightness of the display unit 110.

For example, the control unit 230 may control the brightness of the display unit 110 of FIG. 3 to be lower than that of the display unit 110 of FIG. 4. Also, the control unit 130 may control the brightness of the display unit 110 of FIG. 4 to be lower than that of the display unit 110 of FIG. 5.

The control unit 230 may control the bringtness of display unit to protect the user's privacy. For example, when the intensity of illumination measured by the photo sensor 225 is lower than 220 lux, the control unit 130 controls the brightness of the display unit 110 such that the content displayed on the display unit 110 is recognized only by a user, but not by people who are located adjacent to the user. When the intensity of illumination measured by the photo sensor 225 is equal to or greater than 220 lux, the control unit 130 controls the brightness of the display unit 110 such that the content displayed on the display unit 110 is recognized by the user and the people who are located adjacent to the user. Accordingly, the user may protect his/her privacy by rotating the cover 120.

Power consumption when the brightness of the display unit 110 is high may be greater than that when the brightness of the display unit 110 is low. The control unit 130 controls the display unit 110 such that power consumption changes according to the intensity of illumination measured by the photo sensor 225. For example, the control unit 130 controls the display unit 110 such that power consumption when the measured intensity of illumination is lower than 220 lux is less than that when the measured intensity of illumination is equal to or greater than 220 lux. Thus, the user may control the power consumption in the portable terminal 100 by rotating the cover 120. The control unit 130 may control the display unit such that as the angle increases, the power consumption increases.

According to another embodiment, the control unit 130 may control the display unit such that as the angle decreases, the power consumption increases.

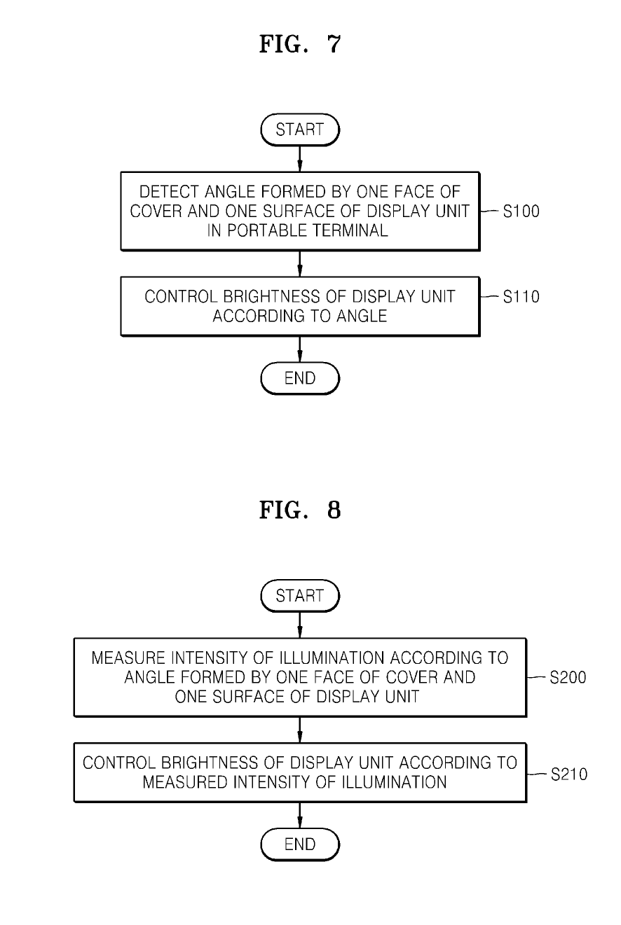

FIG. 7 is a flowchart of a method of controlling the portable terminal 100 of FIG. 2 according to an embodiment of the present invention.

Referring to FIG. 7, an angle formed by a face of the cover 120 and a surface of the display unit 110 in the portable terminal 100 is detected in step S100. The control unit 130 detects the angle formed by the face of the cover 120 and the surface of the display unit 110. The control unit 130 may directly measure the angle formed by the face of the cover 120 and the surface of the display unit 110. According to another embodiment, the control unit 130 may measure the angle formed by the face of the cover 120 and the surface of the display unit 110, based on a value measured using another device.

The brightness of the display unit 110 is controlled according to the detected angle in step S110. The control unit 130 may control the brightness of the display unit 110 such that the larger the angle formed by the face of the cover 120 and the surface of the display unit 110, the higher the brightness of the display unit 110. According to another embodiment, the control unit 130 may control the brightness of the display unit 110 such that the smaller the angle formed by the face of the cover 120 and the surface of the display unit 110, the higher the brightness of the display unit 110.

FIG. 8 is a flowchart of a method of controlling the portable terminal 200 of FIG. 6 according to another embodiment of the present invention.

Referring to FIG. 8, the intensity of illumination is measured according to an angle formed by a face of the cover 20 and a surface of the display unit 110 in the portable terminal 200 in step S200. The larger the angle formed by the face of the cover 20 and the surface of the display unit 110, the higher the intensity of illumination measured by the photo sensor 225.

The brightness of the display unit 110 is controlled according to the measured intensity of illumination in step S210. The control unit 230 may control the brightness of the display unit 110 such that the higher the measured intensity of illumination, the higher the brightness of the display unit 110. According to another embodiment, the control unit 230 may control the brightness of the display unit 110 such that the lower the measured intensity of illumination, the higher the brightness of the display unit 110.

According to the embodiments of the present invention, the privacy of a user of a portable terminal may be easily protected. Further, power consumption in the portable terminal may be decreased, and the duration of a battery included in the portable terminal may be increased.

It should be understood that the embodiments described therein should be considered in a descriptive sense only and not for purposes of limitation. Descriptions of features or aspects within each embodiment should be considered as available for other similar features or aspects in other embodiments.

While certain embodiments of the present invention have been described with reference to the figures, it will be understood by those of ordinary skill in the art that various changes in form and details may be made therein without departing from the spirit and scope of the present invention as defined by the appended claims and their equivalents.

What is claimed is:

1. A portable terminal comprising:
a display unit configured to display an image;
a cover disposed to be rotated with respect to an edge of the display unit as an axis; and
a control unit configured to control brightness of the display unit according to an angle formed by a face of the cover and a surface of the display unit.

2. The portable terminal of claim 1, wherein the control unit is further configured to control the brightness of the display unit such that as the angle increases, the brightness of the display unit increases.

3. The portable terminal of claim 1, wherein the control unit is further configured to control the brightness of the display unit such that as the angle decreases, the brightness of the display unit increases.

4. The portable terminal of claim 1, wherein the control unit is further configured to control the brightness of the display unit such that the brightness of the display unit changes continuously according to the angle.

5. The portable terminal of claim 1, wherein the control unit is further configured to control the brightness of the display unit such that the brightness of the display unit changes discretely according to the angle.

6. The portable terminal of claim 1, further comprising a photo sensor configured to measure an intensity of illumination that depends on the angle, and
wherein the control unit is further configured to control the brightness of the display unit according to the measured intensity of illumination.

7. The portable terminal of claim 6, wherein as the angle increases, the measured intensity of illumination increases.

8. The portable terminal of claim 6, wherein the control unit is further configured to control the brightness of the display unit such that as the measured intensity of illumination increases, the brightness of the display unit increases.

9. The portable terminal of claim 6, wherein the control unit is further configured to control the brightness of the display unit such that as the measured intensity of illumination decreases, the brightness of the display unit increases.

10. A portable terminal comprising:
a display unit configured to display an image;
a cover disposed to be rotated with respect to an edge of the display unit as an axis; and
a control unit configured to control the display unit such that power consumption changes according to an angle formed by a face of the cover and a surface of the display unit.

11. The portable terminal of claim 10, wherein the control unit is further configured to control the display unit such that as the angle increases, the power consumption increases.

12. The portable terminal of claim 10, wherein the control unit is further configured to control the display unit such that as the angle decreases, the power consumption increases.

13. A method of controlling a portable terminal, the method comprising:
detecting an angle formed by a face of a cover and a surface of a display unit included in the portable terminal; and
controlling brightness of the display unit according to the angle.

14. The method of claim 13, wherein controlling the brightness of the display unit comprises controlling the brightness of the display unit such that as the angle increases, the brightness of the display unit increases.

15. The method of claim 13, wherein controlling the brightness of the display unit comprises controlling the brightness of the display unit such that as the angle decreases, the brightness of the display unit increases.

16. A method of controlling a portable terminal, the method comprising:
measuring an intensity of illumination according to an angle formed by a face of a cover and a surface of a display unit included in the portable terminal; and
controlling brightness of the display unit according to the measured intensity of illumination.

17. The method of claim 16, wherein as the angle increases, the measured intensity of illumination increases.

18. The method of claim 16, wherein controlling the brightness of the display unit comprises controlling the brightness of the display unit such that as the measured intensity of illumination increases, the brightness of the display unit increases.

19. The method of claim 16, wherein controlling the brightness of the display unit comprises controlling the brightness of the display unit such that as the measured intensity of illumination decreases, the brightness of the display unit increases.
